(19) United States
(12) Patent Application Publication
(10) Pub. No.: US 2011/0225969 A1
(43) Pub. Date: Sep. 22, 2011

(54) COMPRESSOR BYPASS TO EXHAUST FOR PARTICULATE TRAP REGENERATION

(75) Inventors: Thomas Larose, JR., Redford, MI (US); Stephen England, Cedar Falls, IA (US)

(73) Assignee: GM GLOBAL TECHNOLOGY OPERATIONS, INC., Detroit, MI (US)

(21) Appl. No.: 12/727,329

(22) Filed: Mar. 19, 2010

(51) Int. Cl. F02B 33/00; F01N 3/02; F01N 3/10; F01N 3/025

(52) U.S. Cl. 60/605.1; 60/311; 60/299; 123/559.1; 60/274; 60/286

(57) ABSTRACT

An exhaust gas treatment system for an internal combustion engine having an intake air compressor includes an exhaust gas conduit in fluid communication with, and configured to receive exhaust gas from the engine. A particulate filter assembly is in fluid communication with the exhaust gas conduit and periodically receives heated exhaust gas for combustion of carbon and particulates trapped therein. An air conduit extends between and fluidly couples the intake air compressor to the exhaust gas conduit and is configured to inject air from the compressor into the exhaust gas conduit when the particulate filter is receiving heated exhaust gas to assist the combustion of the carbon and particulates.

### FIELD OF THE INVENTION

Exemplary embodiments of the present invention relate to exhaust gas treatment systems for internal combustion engines and, more particularly, to an efficient system for assuring complete regeneration of an exhaust particulate filter.

### BACKGROUND

The exhaust gas emitted from an internal combustion engine, particularly diesel and some configurations of gasoline engines, is a heterogeneous mixture that may contain gaseous emissions such as carbon monoxide (“CO”), unburned hydrocarbons (“HC”) and oxides of nitrogen (“NOₓ”) as well as condensed phase materials (liquids and solids) that constitute particulate matter. Catalyst compositions typically disposed on catalyst supports or substrates are provided in an engine exhaust system to convert certain, or all of these exhaust constituents into non-regulated exhaust gas components.

An exhaust treatment technology, in use for high levels of particulate mater reduction, is the Particulate Filter device (“PF”). There are several known filter structures used in PF's that have displayed effectiveness in removing the particulate matter from the exhaust gas such as ceramic honeycomb wall flow filters, wound or packed fiber filters, open cell foams, sintered metal fibers, etc. Ceramic wall flow filters have experienced significant acceptance in automotive applications.

The filter is a physical structure for removing particulates from exhaust gas and, as a result, the accumulation of filtered particulates will have the effect of increasing the exhaust system backpressure experienced by the engine. To address backpressure increases caused by the accumulation of exhaust gas particulates, the PF is periodically cleaned, or regenerated. Regeneration of a PF in vehicle applications is typically automatic and is controlled by an engine or other controller based on signals generated by engine and exhaust system sensors. The regeneration event involves increasing the temperature of the PF filter to levels that are often above 600° C. in order to burn the accumulated particulates.

One method of generating the temperatures required in the exhaust system for regeneration of the PF is to deliver increased levels of CO and unburned HC to an oxidation catalyst device disposed upstream of the PF. The HC may be delivered by injecting fuel directly into the exhaust gas system or may be achieved by late fuel injection in the engine cylinders resulting in unburned HC exiting the exhaust port of the engine with the exhaust gas. The CO and HC may be oxidized in an oxidation catalyst device resulting in an exothermic reaction that raises the temperature of the exhaust gas; electrically heated devices have also been used. The heated exhaust gas travels downstream to the PF and burns the particulate accumulation in the PF filter.

The use of re-circulated exhaust gas (“EGR”) is important to modern internal combustion engines, including both gasoline and diesel fueled engines. Efficient use of EGR generally supports the objectives of realizing high power output from these engines while also achieving high fuel efficiency and economy and while meeting increasingly stringent engine-out exhaust gas emission requirements. The use of forced induction, particularly including exhaust gas driven turbochargers, is also frequently employed to increase the engine intake mass airflow and the power output of the engine by using waste energy derived from the exhaust gas. The efficient use of EGR and turbocharged forced-induction necessitates synergistic design of these systems.

A disadvantage to the use of increasingly larger volumes of EGR is that the re-circulated exhaust gas has already been combusted when it displaces combustion air (i.e. oxygen) in the intake charge. While the EGR chemically slows and cools the combustion process, thereby reducing the formation of NOₓ, the result is a reduction in the oxygen levels required to oxidize the CO and excess HC in the exhaust gas, particularly during the PF regeneration event. Such a reduction in Oxygen (“O₂”) may prevent the exhaust gas from reaching a temperature level sufficient for the efficient combustion of carbon and particulates in the PF as well as resulting in the “slip” of CO and unburned HC through the exhaust treatment components of the exhaust system. In addition, reduced levels of O₂ also significantly slow the burn rate of soot, especially when levels drop below about 6-5%, thereby increasing the PF regeneration time. Increased regeneration times reduce fuel economy and may increase emissions.

### SUMMARY OF THE INVENTION

In an exemplary embodiment, an exhaust gas treatment system for an internal combustion engine comprises an internal combustion engine having an intake air compressor, an exhaust gas conduit in fluid communication with, and configured to receive an exhaust gas from, the internal combustion engine and a particulate filter assembly in fluid communication with the exhaust gas conduit, and configured to periodically receive heated exhaust gas for combustion of carbon and particulates trapped therein. An air conduit extends between and fluidly couples a compressed air conduit of the intake air compressor to the exhaust gas conduit. A valve is disposed in the air conduit and is configured to inject compressed air from the intake air compressor into the exhaust gas conduit when the particulate filter is receiving heated exhaust gas to assist the combustion of the carbon and particulates.

In another exemplary embodiment, an exhaust system for an internal combustion engine comprises an exhaust driven, intake air compressor configured to receive an exhaust gas from the internal combustion engine and to deliver compressed air, through a compressed air conduit, to an intake system of the engine. An exhaust gas conduit is in fluid communication with, and configured to receive an exhaust gas from an outlet of the exhaust driven, intake air compressor. An air conduit extends between and fluidly couples the compressed air conduit of the exhaust driven, intake air compressor to the exhaust gas conduit. A valve is disposed in the air conduit and is configured to inject compressed air from the compressor into the exhaust gas conduit. A hydrocarbon supply is connected to and is in fluid communication with the exhaust gas conduit for delivery of a hydrocarbon thereto and formation of an exhaust gas, hydrocarbon and air mixture therein. An oxidation device, downstream of the air conduit and the hydrocarbon supply, is configured to receive the compressed air, exhaust gas and hydrocarbon mixture and induce a rapid exothermic oxidation reaction of the mixture to thereby heat the exhaust gas and particulate filter assembly in fluid communication with the exhaust gas conduit is configured to receive the heated exhaust gas from the oxidation device for combustion of carbon and particulates trapped therein.

In yet another exemplary embodiment, a method for regenerating an exhaust gas particulate filter in an exhaust system for an internal combustion engine that comprises an intake air compressor configured to deliver compressed air, through a compressed air conduit, to an intake system of the engine, an exhaust gas conduit in fluid communication with, and configured to receive an exhaust gas from, the internal combustion engine, a air conduit extending between and fluidly coupling the compressed air conduit of the intake air compressor to the exhaust gas conduit, a valve disposed in the air conduit and configured to inject compressed air from the compressor into the exhaust gas conduit, a hydrocarbon supply connected to and in fluid communication with the exhaust gas conduit for delivery of a hydrocarbon thereto and formation of an exhaust gas, hydrocarbon and compressed air mixture therein, an oxidation device downstream of the air conduit and the hydrocarbon supply, and configured to receive the compressed air, exhaust gas and hydrocarbon mixture and induce a rapid exothermic oxidation reaction of the mixture to thereby heat the exhaust gas; and a particulate filter assembly in fluid communication with the exhaust gas conduit, and configured to receive the heated exhaust gas from the oxidation device for combustion of carbon and particulates trapped therein and a controller in signal communication with a plurality of sensors in fluid communication with exhaust gas conduit and configured to initiate delivery of the hydrocarbon and the air to assist the combustion of the carbon and particulates, comprises operating the controller through signal communication with the sensors to determine if the exhaust system backpressure has reached a level indicative of the need to regenerate the exhaust gas particulate filter. Operating the controller through signal communication with the sensors to determine the level of oxygen in the exhaust gas flow. Operating the controller to activate the air injector to add compressed air from the air conduit to the exhaust gas flow if the level of oxygen in the exhaust gas flow is below that required for complete oxidation of hydrocarbon in the exhaust gas, regeneration of the particulate filter assembly, or both.

The above features and advantages, and other features and advantages of the present invention are readily apparent from the following detailed description of the invention when taken in connection with the accompanying drawings.

### BRIEF DESCRIPTION OF THE DRAWINGS

Other objects, features, advantages and details appear, by way of example only, in the following detailed description of the embodiments, the detailed description referring to the drawings in which:

FIG. 1 is a schematic view of an exhaust gas treatment system for an internal combustion engine embodying features of the invention; and

FIG. 2 is a schematic view of another embodiment of an exhaust gas treatment system for an internal combustion engine embodying features of the invention.

### DESCRIPTION OF THE EMBODIMENTS

The following description is merely exemplary in nature and is not intended to limit the present disclosure, application or uses. It should be understood that throughout the drawings, corresponding reference numerals indicate like or corresponding parts and features.

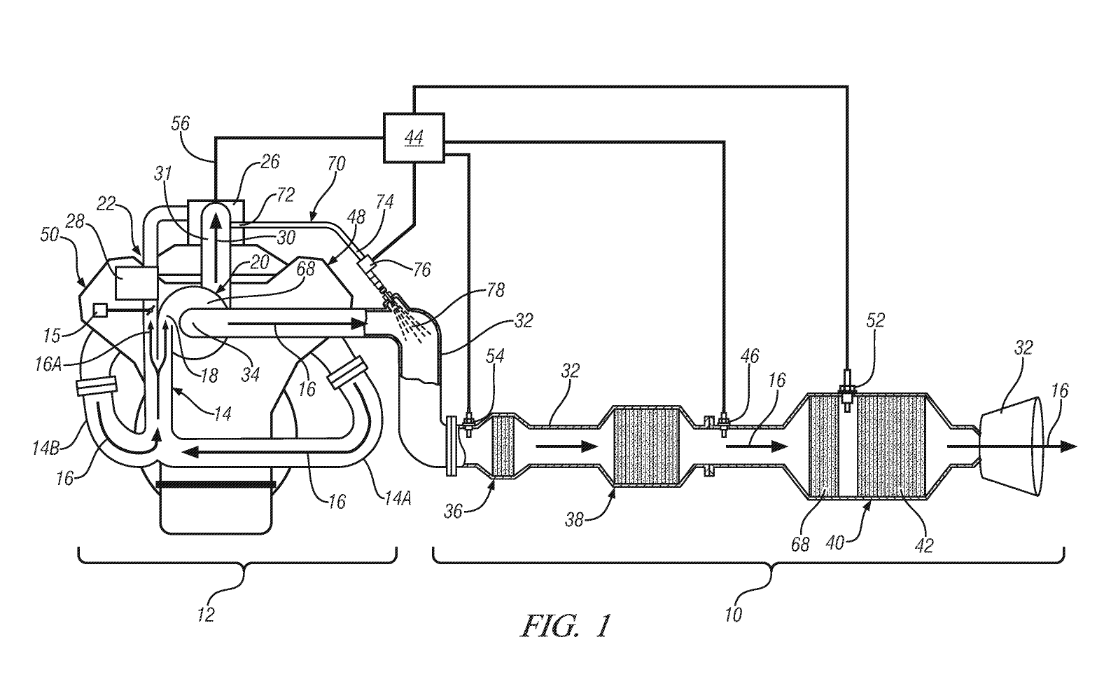

Referring now to FIG. 1, one exemplary embodiment of the invention is directed to an exhaust gas treatment system, referred to generally as 10, for application to an internal combustion engine 12. As indicated, the internal combustion engine 12 may be any type (diesel, gasoline or other) that produces elevated levels of particulates in the exhaust gas exiting therefrom and the invention described herein can be implemented in various engine systems.

In an exemplary embodiment, the exhaust system 10 includes a primary exhaust conduit 14 that is the culmination of first and second exhaust conduits 14A and 14B that are in fluid communication with exhaust ports, (not shown) of the internal combustion engine 12. The first exhaust conduit 14A is configured to collect, and to conduct an exhaust gas flow 16 from a first cylinder or bank of cylinders 48, of the internal combustion engine 12 and to the inlet 18 of an engine intake air compressor such as exhaust driven turbocharger 20. In another embodiment, the engine intake air compressor 20 may be an engine driven supercharger, for instance. The second exhaust conduit 14B is configured to collect and to conduct an exhaust gas flow 16 from a second cylinder or bank of cylinders 50, of the internal combustion engine 12 and also to the inlet 18 of the exhaust driven turbocharger 20. The turbocharger 20 utilizes excess exhaust energy to compress inlet air 30 which is delivered, through compressed air conduit 31, to the intake manifold 26 of the internal combustion engine 12. A portion 16A of the exhaust gas flow 16 is diverted to an exhaust gas recirculation (“EGR”) system 22 where it is may pass through an exhaust gas cooler 28 and is subsequently mixed with the compressed inlet air 30 from turbocharger 20 prior to being introduced into the intake manifold 26 of the internal combustion engine 12. The volume of the EGR exhaust gas 16A that is diverted to the EGR system 22 is regulated by an EGR valve 15 that is located in the EGR system 22 between the exhaust conduit 14 and the intake manifold 26 of the engine 12.

The remainder of the exhaust system 10 includes a downstream exhaust gas conduit 32 in fluid communication with the outlet 34 of the turbocharger 20 and comprises several segments that function to transport the exhaust gas flow 16 to various exhaust treatment components of the exhaust system 10. The exhaust treatment components may include a first oxidation catalyst (“OC”) 36 that is useful in treating unburned gaseous and non-volatile HC and CO, which are oxidized to form carbon dioxide and water. The OC 36 is typically coated with an oxidation catalyst compound that includes a platinum group metal such as platinum (Pt), palladium (Pd), rhodium (Rh) or other suitable oxidizing catalysts, or a combination thereof. The oxidation of the HC and CO in the OC 36 is an exothermic reaction which will be discussed in further detail below. A selective catalyst reduction device (“SCR”) 38 may be disposed downstream of the OC 36 and is typically coated with an SCR catalyst composition that contains a zeolite and one or more base metal components such as iron (“Fe”), cobalt (“Co”), copper (“Cu”) or vanadium (“V”) that can operate to effectively convert NOₓ constituents in the exhaust gas flow 16 in the presence of a reductant such as ammonia (‘NH₃”).

In an exemplary embodiment, an exhaust gas particulate filter, in this case a particulate filter (“PF”) 40 is located within the exhaust system 10, downstream of the SCR 38 and OC 36 and operates to filter the exhaust gas flow 16 of carbon and other particulates. The PF 40 may be constructed using a ceramic wall flow monolith exhaust gas filter 42 having walls through which the exhaust gas flow 16 is forced to migrate. It is through the wall flow mechanism that the exhaust gas flow 16 is filtered of carbon and other particulates. The filtered particulates are deposited within the exhaust gas filter 42 of the PF 40 and, over time, will have the effect of increasing the exhaust gas backpressure experienced by the internal combustion engine 12. The increase in the backpressure of the exhaust gas flow 16 caused by the accumulation of particulate matter in the PF 40 requires that the PF be periodically cleaned, or regenerated in order to maintain the efficiency of the internal combustion engine 12. Regeneration involves the oxidation or burning of the accumulated carbon and other particulates in what is typically a high temperature (>600° C.) environment.

Referring again to FIG. 1, in one exemplary embodiment, a controller such as engine controller 44 is operably connected to, and monitors, the exhaust system 10 through a number of sensors such as pressure sensor 46, temperature sensor 52 and oxygen sensor 54. As used herein the term controller refers to an application specific integrated circuit (ASIC), an electronic circuit, a processor (shared, dedicated or group) and memory that executes one or more software of firmware programs, a combinational logic circuit, and/or other suitable components that provide the described functionality. Upon a determination that the exhaust system backpressure has reached a predetermined level indicative of the need to regenerate the PF 40, the engine controller 44 will adjust the delivery rate and/or the timing or both 56 of fuel delivery to the internal combustion engine 12 resulting in the delivery of unburned HC to the exhaust gas flow 16 resulting in an HC/exhaust gas mixture in the exhaust gas conduit 32. The HC/exhaust gas mixture enters the OC 36 that induces a rapid oxidation reaction of the HC to form CO₂ and H₂O:

HC+O₂→CO₂+H₂O

The oxidation reaction is exothermic and serves to raise the temperature of the exhaust gas 16 to a level (>600° C.) suitable for regeneration of the carbon and particulate matter in the ceramic wall flow monolith filter 42 of the PF 40.

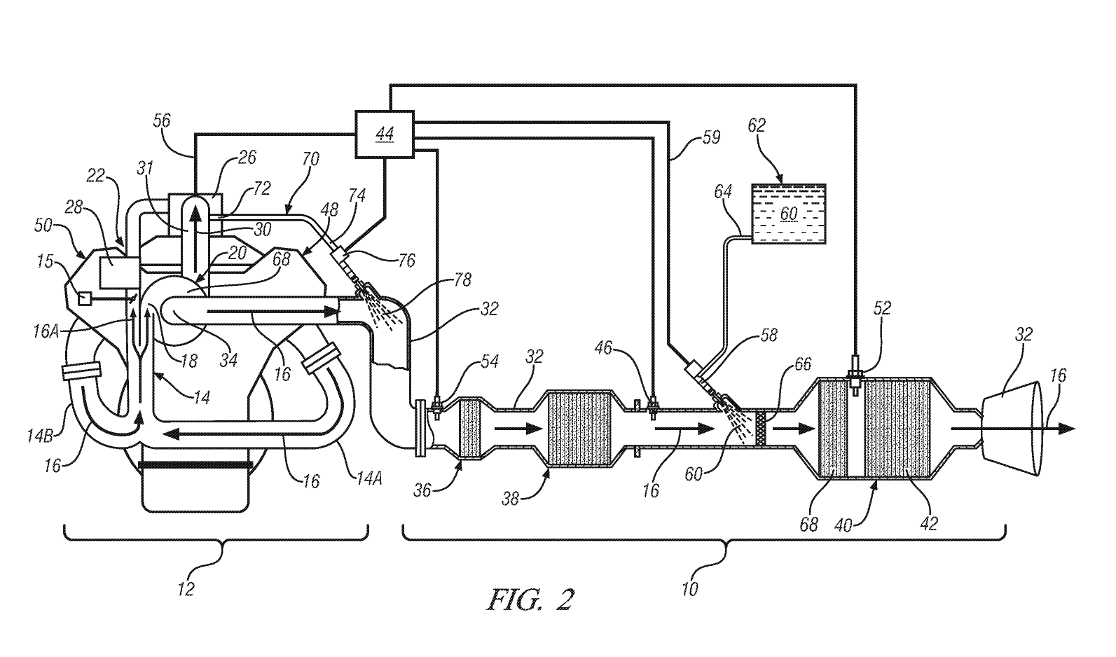

In another exemplary embodiment, illustrated in FIG. 2, an HC, or fuel injector 58 is disposed in fluid communication with the exhaust gas flow 16 in the downstream exhaust gas conduit 32 upstream of the PF 40. The fuel injector 58 is in fluid communication with HC 60 in fuel supply tank 62 through fuel conduit 64. The fuel injector 58 is signally connected with the controller 44 and is configured to introduce unburned HC 60 into the exhaust gas stream for delivery to the PF 40. A mixer or turbulator 66 may also be disposed within the exhaust conduit 32, in close proximity to the HC injector 58, to further assist in thorough mixing of the HC with the exhaust gas 16. In the embodiment illustrated in FIG. 2, a second oxidation catalyst (“OC2”) 68 is disposed within the canister of the PF 40, upstream of the exhaust gas filter 40. In a manner similar to that described above, upon a determination that the exhaust system backpressure has reached a predetermined level indicative of the need to regenerate the PF 40, the controller 44 activates the HC injector 58 to deliver HC into the downstream exhaust gas conduit 32 for mixing with the exhaust gas 16. The HC/exhaust gas mixture enters the PF 40 and flows through OC2 68 that induces a rapid oxidation reaction of the HC to form CO₂ and H₂O:

HC+O₂→CO₂+H₂O

The oxidation reaction is exothermic and serves to raise the temperature of the exhaust gas 16 to a level (>600° C.) suitable for regeneration of the carbon and particulate matter in the ceramic wall flow monolith filter 42. Following its exit from the OC2 68, the heated exhaust gas 16 flows downstream through the ceramic wall flow monolith filter 42 where it effectively combusts the carbon and other particulates trapped therein. During the regeneration event, carbon (“C”) is oxidized in the presence of oxygen (“O₂”) to generate carbon dioxide (“CO₂”) and carbon monoxide (“CO”):

C+O₂→CO₂+CO

While two examples of the exhaust system 10 have been described, other suitable configurations are also contemplated. For example, the exemplary embodiment illustrated in FIG. 2 and described above may be configured such that the HC or fuel injector 58 is located upstream of the OC 36. In such an instance, the OC 36 may be sized to oxidize all of the unburned HC in the downstream exhaust gas conduit 32 thereby dispensing with the need for an additional OC2 68 located closely adjacent to the upstream end of the exhaust gas filter 42.

Referring to FIGS. 1 and 2, as increasingly large volumes of EGR 16A are diverted to the engine intake manifold 26 and passed through the internal combustion engine 12, the residual O₂ that is available in the exhaust gas flow 16 in the downstream exhaust gas conduit 32 is significantly reduced. Significant reductions in O₂ exhaust levels may adversely affect the oxidation reactions in both OC 36 and OC2 68 (if equipped) as well as the regeneration or combustion reaction in the exhaust gas filter 42 of the PF 40 since both reactions rely on O₂ to proceed. In order to assure that sufficient O₂ is present in the exhaust gas 16 flowing through downstream exhaust gas conduit 32 for proper operation of the OC 36 and OC2 68 as well as for complete regeneration of the PF 40 an air conduit 70 has an inlet end 72 associated with the compressed air conduit 31 of the turbocharger 20 and an outlet end 74 in fluid communication with the downstream exhaust conduit 32 of the exhaust system 10. The air conduit may include an in-line valve for regulating the flow of air therethrough such as an air injector 76 at the outlet end 74. The injector is signally connected to the controller 44 and is configured to inject compressed air 78 into the exhaust gas flow 16 upon activation by the controller.

In an exemplary embodiment, upon a determination that the exhaust system backpressure has reached a predetermined level indicative of the need to regenerate the PF 40, the engine controller 44 will determine the level of additional O₂ required in the exhaust gas flow 16 through signal communication with oxygen sensor 54. If O₂ levels in the exhaust gas flow 16 are below that required for complete oxidation of CO and HC, regeneration of the PF 40 or both, the controller will activate the air injector 76 to inject compressed air 78 from the turbocharger compressed air conduit 31 to the exhaust gas flow 16 in the downstream exhaust gas conduit 32. It has been determined that an increase of O₂ in the exhaust gas 16 of about two percent can result in a ten percent increase in the efficiency of PF 40 regeneration. Once O₂ levels are at a predetermined level in the exhaust gas flow 16, the controller will adjust the delivery rate and/or the timing or both 56 of fuel delivery to the internal combustion engine 12 resulting in the delivery of unburned HC to the exhaust gas flow 16, FIG. 1 or, alternatively, it may activate an HC injector 58 to deliver HC 60 into the downstream exhaust gas conduit 32 for mixing with the exhaust gas 16, FIG. 2. In either case, the controller 44 may monitor the temperature of the exothermic oxidation reaction in the OC 36, the OC2 68 and the ceramic wall flow monolith filter 42 through temperature sensor 52 and adjust the HC delivery rate as well as the delivery rate of air 78 to maintain a predetermined exhaust system temperature and function.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the present application.

What is claimed is:

1. An exhaust gas treatment system for an internal combustion engine comprising:
an internal combustion engine having an intake air compressor;
an exhaust gas conduit in fluid communication with, and configured to receive an exhaust gas from, the internal combustion engine;
a particulate filter assembly in fluid communication with the exhaust gas conduit, and configured to periodically receive heated exhaust gas for combustion of carbon and particulates trapped therein;
an air conduit extending between and fluidly coupling a compressed air conduit of the intake air compressor to the exhaust gas conduit; and
a valve disposed in the air conduit and configured to inject compressed air from the intake air compressor into the exhaust gas conduit when the particulate filter is receiving heated exhaust gas to assist the combustion of the carbon and particulates.

2. The exhaust gas treatment system of claim 1, further comprising:
a hydrocarbon supply connected to and in fluid communication with the exhaust gas conduit for delivery of a hydrocarbon thereto and formation of an exhaust gas and hydrocarbon mixture therein; and
an oxidation device downstream of the hydrocarbon supply and the valve and configured to receive the exhaust gas, hydrocarbon and compressed air mixture and induce a rapid exothermic oxidation reaction of the mixture to thereby heat the exhaust gas for delivery to the particulate filter assembly.

3. The exhaust gas particulate filter system for an internal combustion engine of claim 2, wherein the oxidation catalyst compound includes a platinum group metal such as platinum (Pt), palladium (Pd), rhodium (Rh) or other suitable oxidizing catalysts, or a combination thereof.

4. The exhaust gas treatment system of claim 1, wherein the intake air compressor comprises an exhaust driven turbocharger.

5. The exhaust gas treatment system of claim 1, wherein the intake air compressor comprises an engine driven supercharger.

6. The exhaust gas treatment system of claim 2, further comprising:
a controller in signal communication with a plurality of sensors in fluid communication with exhaust gas conduit and configured to initiate delivery of the hydrocarbon and the air to assist the combustion of the carbon and particulates.

7. The exhaust gas treatment system of claim 6, wherein the valve disposed in the air conduit is an air injector in signal communication with the controller.

8. The exhaust gas treatment system of claim 6, wherein the hydrocarbon supply further comprises a hydrocarbon injector in signal communication with the controller.

9. The exhaust gas particulate filter system of claim 6, wherein the controller is configured to adjust the delivery rate and/or the timing or both of fuel delivery to the engine to deliver unburned hydrocarbon to the exhaust gas conduit.

10. The exhaust gas particulate filter system of claim 1, wherein the internal combustion engine comprises a diesel engine.

11. The exhaust gas particulate filter system of claim 1, wherein the internal combustion engine comprises a gasoline engine.

12. An exhaust system for an internal combustion engine comprising:
an exhaust driven, intake air compressor configured to receive an exhaust gas from the internal combustion engine and to deliver compressed air through a compressed air conduit to an intake system of the engine;
an exhaust gas conduit in fluid communication with, and configured to receive an exhaust gas from an outlet of the exhaust driven, intake air compressor;
an air conduit extending between and fluidly coupling the compressed air conduit of the exhaust driven, intake air compressor to the exhaust gas conduit;
a valve disposed in the air conduit and configured to inject compressed air from the exhaust driven, intake air compressor into the exhaust gas conduit;
a hydrocarbon supply connected to and in fluid communication with the exhaust gas conduit for delivery of a hydrocarbon thereto and formation of an exhaust gas, hydrocarbon and air mixture therein;
an oxidation device downstream of the air conduit and the hydrocarbon supply, and configured to receive the compressed air, exhaust gas and hydrocarbon mixture and induce a rapid exothermic oxidation reaction of the mixture to thereby heat the exhaust gas; and
a particulate filter assembly in fluid communication with the exhaust gas conduit, and configured to receive the heated exhaust gas from the oxidation device for combustion of carbon and particulates trapped therein.

13. The exhaust system of claim 12, further comprising:
a controller in signal communication with a plurality of sensors in fluid communication with exhaust gas conduit and configured to initiate delivery of the hydrocarbon and the compressed air to the exhaust gas conduit.

14. The exhaust system of claim 12, wherein the internal combustion engine comprises a diesel engine.

15. The exhaust system of claim 12, wherein the internal combustion engine comprises a gasoline engine.

16. A method for regenerating an exhaust gas particulate filter in an exhaust system for an internal combustion engine that comprises an intake air compressor configured to deliver compressed air, through a compressed air conduit, to an intake system of the engine, an exhaust gas conduit in fluid communication with, and configured to receive an exhaust gas from, the internal combustion engine, a air conduit extending between and fluidly coupling the compressed air conduit of the intake air compressor to the exhaust gas conduit, a valve disposed in the air conduit and configured to inject compressed air from the compressor into the exhaust gas conduit;
a hydrocarbon supply connected to and in fluid communication with the exhaust gas conduit for delivery of a hydrocarbon thereto and formation of an exhaust gas, hydrocarbon and compressed air mixture therein;
an oxidation device downstream of the air conduit and the hydrocarbon supply, and configured to receive the compressed air, exhaust gas and hydrocarbon mixture and induce a rapid exothermic oxidation reaction of the mixture to thereby heat the exhaust gas;
a particulate filter assembly in fluid communication with the exhaust gas conduit, and configured to receive the heated exhaust gas from the oxidation device for combustion of carbon and particulates trapped therein; and
a controller in signal communication with a plurality of sensors in fluid communication with exhaust gas conduit and configured to initiate delivery of the hydrocarbon and the air to assist the combustion of the carbon and particulates, comprising:
operating the controller through signal communication with the sensors to determine if the exhaust system backpressure has reached a level indicative of the need to regenerate the exhaust gas particulate filter;
operating the controller through signal communication with the sensors to determine the level of oxygen in the exhaust gas flow;
operating the controller to activate the air injector to add compressed air from the air conduit to the exhaust gas flow if the level of oxygen in the exhaust gas flow is below that required for complete oxidation of hydrocarbon in the exhaust gas, regeneration of the particulate filter assembly, or both.

17. The method for regenerating an exhaust gas particulate filter of claim 16, further comprising;
operating the controller to increase the level of hydrocarbon in the exhaust gas once oxygen levels are at a predetermined level in the exhaust gas flow required for complete oxidation of hydrocarbon in the exhaust gas, regeneration of the particulate filter assembly, or both.

18. The method for regenerating an exhaust gas particulate filter of claim 16, further comprising;
operating the controller to monitor the temperature of an exothermic oxidation reaction in the oxidation device and the particulate filter through signal communication with the sensors and adjusting the hydrocarbon delivery rate as well as the delivery rate of compressed air to maintain a predetermined exhaust system temperature.
